(19) United States
(12) Patent Application Publication
(10) Pub. No.: US 2006/0128572 A1
(43) Pub. Date: Jun. 15, 2006

(54) Phosphoric esters of polyisobutene-substituted aromatic hydroxy compounds

(75) Inventors: Arno Lange, Bad Durkheim (DE); Hans Peter Rath, Grunstadt (DE); Ulrich Karl, Ludwigshafen (DE); Georg Josef Doring, Mannheim (DE); Helmut Witteler, Wachenheim (DE); Ralf Norenberg, Ingelheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/542,345

(22) PCT Filed: Jan. 22, 2004
(86) PCT No.: PCT/EP04/00537

§ 371 Date: Jul. 14, 2005

(30) Foreign Application Priority Data
Jan. 23, 2003 (DE) 103 02 626.6

(51) Int. Cl. C07F 9/12; C10M 137/04; C10L 1/26

(52) U.S. Cl. 508/433; 44/375; 558/87; 558/90; 558/156; 558/207

(57) ABSTRACT

The present invention relates to phosphoric esters of polyisobutene-substituted aromatic hydroxyl compounds, to a process for preparing them and also to their use.

The present invention relates to phosphoric esters of polyisobutene-substituted aromatic hydroxyl compounds, to a process for preparing them and also to their use.

Amphiphilic polyalkenyl derivatives which are used for modifying surface properties or interface behavior, for example, as corrosion inhibitors, friction modifiers, emulsifiers or dispersants, are known.

For instance, the international patent application PCT/EP 02/09608 describes a polymer composition which comprises firstly a polyisobutenic component and secondly a polymer differing therefrom. The polyisobutenic component may be selected from derivatized polyisobutenes. These derivatives are, for example, polyisobutenes which have been epoxidized, hydroformylated, hydroxylated, halogenated, silylated or functionalized with thio groups or sulfonic acid groups. These compositions are said to have good mechanical properties and/or good interface properties.

U.S. Pat. No. 4,578,178 describes the use of polyalkenylthiophosphonic acids or esters thereof for preventing the formation of deposits in crude oil or petrochemical products.

U.S. Pat. No. 4,031,017 describes polyisobutene-substituted Mannich adducts in which the polyisobutene radical is phosphosulfurated. The compounds are used as antioxidants and detergents in lubricants.

U.S. Pat. No. 4,778,480 describes polyalkenyl-substituted thiophosphonic acids which are used for color stabilization in diesel fuels.

U.S. Pat. No. 4,244,828 describes a polyalkenylthiophosphonic acid or a polyalkenylphosphonic thioester as an intermediate. Its reaction product is used in lubricant compositions.

A disadvantage of the sulfur-containing phosphonic acids of the four US documents mentioned is their odor and their color, which make them appear unsuitable for certain applications. Furthermore, the storage stability and the effectiveness of this compound class is unsatisfactory. In view of the combustion products of the sulfur present, especially sulfur dioxide, the use especially of such sulfur-containing products in fuel oil compositions, such as diesel and gasoline fuels and heating oil, is inconceivable for environmental and political reasons.

It is an object of the present invention to provide novel amphiphilic polyalkenyl derivatives having good application properties. They should in particular be odorless and substantially colorless, have a sufficient storage stability and/or good surface-active properties.

We have found that this object is achieved by a phosphoric ester of the formula I 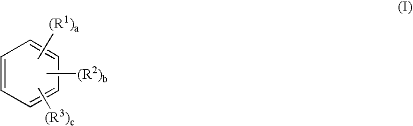
where

each R¹ is independently a group

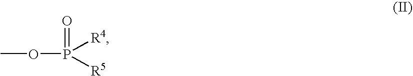

R⁴ and R⁵ are each independently halogen, OR⁶, SR⁶, NR⁶R⁷ or a 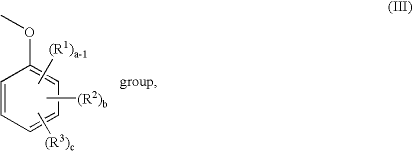
R⁶ and R⁷ are each independently H, C₁-C₂₀-alkyl or C₂-C₄₀₀₀-alkyl which is interrupted by at least one moiety which is selected from O, S and NR⁸, and R⁶ and R⁷ together with the nitrogen atom to which they are bonded may also form a ring, and R⁶ and R⁷ are also aryl, aralkyl or cycloalkyl; and
R⁸ is as defined for R⁶ and R⁷;
R² is a polyisobutene radical;
each R³ is independently OH, C₁-C₂₄-alkyl, C₁-C₂₄-alkoxy or halogen;
a and b are each a number from 1 to 3 and
c is a number from 0 to 4,
where the sum of a, b and c is from 2 to 6
and salts thereof.

In preferred phosphoric esters I, neither R⁴ nor R⁵ is an SR⁶ radical. Particular preference is given to phosphoric esters I in which none of the R⁶ or R⁷ radicals or III contains sulfur either. This is true especially when the phosphoric ester according to the invention is to be used in fuel compositions.

However, if the phosphoric esters I according to the invention are to be used in lubricant compositions or for corrosion protection, phosphoric esters I having sulfur-containing R⁴ and R⁵ radicals are also suitable.

For the purposes of the present invention, C₁-C₂₀-alkyl is a linear or branched alkyl group, such as methyl, ethyl, n-propyl, isopropyl, n-butyl, sec-butyl, isobutyl, tert-butyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl or eicosyl and also their positional isomers. C₁-C₂₄-Alkyl is additionally heneicosyl, docosyl, tricosyl and tetracosyl and also their positional isomers. The alkyl radical is optionally substituted by at least one group selected from cycloalkyl, halogen, OR⁹, SR⁹ and NR⁹R¹⁰, where R⁹ and R¹⁰ are each independently H or C₁-C₆-alkyl. The alkyl radical is preferably not substituted by an SR⁹ radical. This is true especially when the phosphoric ester according to the invention is to be used in fuel compositions.

The C₂-C₄₀₀₀ radical which is interrupted by at least one O, S or NR⁸ moiety may also be substituted by at least one group selected from cycloalkyl, halogen, OR⁹, SR⁹ and NR⁹R¹⁰. The C₂-C₄₀₀₀-alkyl radical is preferably neither interrupted by an S moiety nor substituted by an SR⁹ radical. This is true especially when the phosphoric ester according to the invention is to be used in fuel compositions.

The C₂-C₄₀₀₀-alkyl radical is preferably a radical of the formula IV [symbol]
(CR¹¹R¹²)ₖ(CR¹³R¹⁴)ₘ—X [symbol] ₗ—(CR¹¹R¹²)ₖ(CR¹³R¹⁴)ₘ—Y (IV)
where R¹¹, R¹², R¹³ and R¹⁴ are each independently H or C₁-C₄-alkyl,
X is O, S or NR¹⁵,
Y is H, OR¹⁶, SR¹⁶ or NR¹⁶R¹⁷,
R¹⁵ is H or C₁-C₄-alkyl,
R¹⁶ and R¹⁷ are each independently H or C₁-C₆-alkyl,
k is a number from 1 to 6,
m is a number from 0 to 5 where the sum of k and m is from 1 to 6, and
l is a number from 1 to 1000.

The alkylene group (CR¹¹R¹²)ₖ(CR¹³R¹⁴)ₘ is, for example, 1,2-ethylene, 1,2-propylene, 1,3-propylene, 1,2-butylene, 2,3-butylene or 1,4-butylene. It is preferably 1,2-ethylene or 1,2-propylene, more preferably 1,2-ethylene.

k and m are preferably a number from 1 to 3, especially 1.

The sum of k and m is preferably a number from 2 to 4 and more preferably 2.

l is preferably a number from 1 to 300, for example from 1 to 100, more preferably from 1 to 60, for example from 1 to 40, in particular from 1 to 10 and especially from 1 to 4.

For the purposes of the present invention, C₁-C₄-alkyl is, for example, methyl, ethyl, n-propyl, isopropyl, n-butyl, sec-butyl, isobutyl or tert-butyl; C₁-C₆-alkyl is additionally pentyl, hexyl and its positional isomers.

When two alkyl radicals R⁶ and R⁷ together with the nitrogen atom to which they are bonded form a ring, it is preferably, for example, a piperidine, piperazine or morpholine ring.

Aryl is preferably optionally substituted phenyl or naphthyl. Suitable substituents are, for example, halogen, C₁-C₄-alkyl and C₁-C₄-alkoxy.

Aralkyl is preferably benzyl or 2-phenylethyl.

Cycloalkyl is preferably C₃-C₁₀-cycloalkyl, such as cyclopropyl, cyclopentyl, cyclohexyl, cyclooctyl or cyclodecyl, and more preferably C₃-C₆-cycloalkyl. The cycloalkyl radical may be interrupted by at least one moiety selected from O, S and NR⁸, and/or substituted by at least one group selected from C₁-C₂₀-alkyl, halogen, OR⁹, SR⁹ and NR⁹R¹⁰. Cycloalkyl interrupted by at least one O, S or NR⁸ moiety is, for example, pyrrolidyl, tetrahydrofuranyl, tetrahydrothienyl, oxazolidinyl, piperidinyl, piperazinyl or morpholinyl, and it will be appreciated that the cycloalkyl radical must not be bonded via the ring heteroatom to the oxygen, sulfur or nitrogen atom of the R⁴ or R⁵ radicals. The cycloalkyl radical is preferably neither interrupted by an S moiety nor substituted by an SR⁹ radical. This is true especially when the phosphoric ester according to the invention is to be used in fuel compositions.

Halogen is preferably Cl or Br and more preferably Cl.

In the salts of the polyisobutenylphosphoric ester according to the invention, R⁴ and/or R⁵ is/are, for example, each a O-Mⁿ⁺_{1/n} or S-Mⁿ⁺_{1/n} radical where M is a cation.

Suitable cations are the cations of alkali metals such as lithium, sodium or potassium, of alkaline earth metals such as magnesium or calcium, and of heavy metals such as iron, zinc or silver, and additionally ammonium cations [NR^{a}R^{b}R^{c}R^{d}]+, where R^{a} to R^{d} are each independently H, C₁-C₆-alkyl, C₁-C₆-alkoxy, aryl or aralkyl. Preferred cations are alkali metal and alkaline earth metal cations and also ammonium cations.

In the phosphoric ester according to the invention of the formula I, a is preferably 1 or 2 and more preferably 1.

b is preferably 1 or 2 and more preferably 1.

c is preferably 0 or 1 and more preferably 0.

R⁴ and R⁵ are each independently halogen, OR⁶, SR⁶ or NR⁶R⁷, and more preferably halogen, OR⁶ or NR⁶R⁷. Preference is also given to the salts thereof.

R⁶ and R⁷ are preferably each independently H, C₁-C₂₀-alkyl which is optionally substituted as defined above, or C₂-C₄₀₀₀-alkyl which is interrupted as defined above and optionally substituted by at least one OR⁹, SR⁹ or NR⁹R¹⁰ radical.

R⁶ and R⁷ are more preferably each independently H. Also, R⁶ and R⁷ are more preferably each independently C₁-C₁₀-alkyl which is optionally substituted by at least one OR⁹, SR⁹ or NR⁹R¹⁰ radical. In addition, R⁶ and R⁷ are more preferably each independently C₂-C₄₀₀₀-alkyl of the formula IV.

Preferred radicals of the formula IV are those in which X is O and Y is OR¹⁶ or in which X is NR¹⁵ and Y is NR¹⁶R¹⁷, i.e. preferred radicals of the formula IV are polyether or polyamine radicals. Preference is also given to radicals of the formula IV in which R¹¹ and R¹³ are each H and R¹² and R¹⁴ are each H or C₁-C₄-alkyl, in particular H or methyl and especially H. In addition, k and m are preferably a number from 1 to 3, in particular 1. The sum of k and m is preferably from 2 to 4, in particular 2. l is preferably a number from 1 to 100, more preferably from 1 to 60, in particular from 1 to 10 and especially from 1 to 4.

Preferred polyether radicals are those of the formula IV.a [symbol]
(CH₂)₂—O [symbol] ₗ—(CH₂)₂—OR¹⁶ (IV.a)
where
l is a number from 1 to 1000, preferably from 1 to 600, more preferably from 1 to 40, in particular from 1 to 10 and especially from 1 to 4 and
R¹⁶ is H or C₁-C₆-alkyl, in particular H, methyl or ethyl.

Preferred radicals are correspondingly di-, tri-, tetra- or pentaethylene glycol radicals and their monoethers and also polyethylene glycol ether radicals having up to 1000 repeating units. Preferred polyethylene glycol ether radicals are those having a number-average molecular weight Mₙ of from 280 to 15 000, for example of about 300, about 400, about 500, about 700, about 1000, about 1500, about 2000, about 3000, about 4000, about 5000, about 7000, about 8000, about 10 000 or about 12 000.

Also suitable as C₂-C₄₀₀₀-alkyl radicals are polyether-containing radicals which are derived from block copolymers of alkylene oxides and alkenes as monomers. Suitable alkylene oxides are, for example, ethylene oxide and propylene oxide. Suitable alkenes are, for example, ethylene, propylene and isobutene.

Preferred polyamine radicals are those of the formula IV.b [symbol]
CH₂)₂—NR¹⁵ [symbol] ₗ—(CH₂)₂—NR¹⁶R¹⁷ (IV.b)
where
l is a number from 1 to 1000, preferably from 1 to 100, more preferably from 1 to 10 and in particular from 1 to 4,
R¹⁵ is H or C₁-C₄-alkyl, in particular H or methyl and especially H and
R¹⁶ and R¹⁷ are each independently H or C₁-C₆-alkyl, in particular H, methyl or ethyl and especially H.

R¹⁶ and R¹⁷ are more preferably each the same radical.

In preferred NR⁶R⁷ radicals, R⁶ and R⁷ are either each the same radical or one of the R⁶ or R⁷ radicals is H, while the other is a radical other than H. Preferred radicals other than H are unsubstituted or OR⁹— or NR⁹R¹⁰-substituted C₁-C₁₀-alkyl or radicals of the formula VI.b.

R⁴ and R⁵ are preferably each independently OR⁶ where R⁶ is H or a radical of the formula IV.a where 1 is from 1 to 4 and R¹⁶ is H or C₁-C₄-alkyl.

The polyisobutene radical R² in the phosphoric ester I according to the invention preferably has a number-average molecular weight Mₙ of from 100 to 1 000 000, more preferably from 100 to 100 000, with greater preference from 200 to 60 000 and in particular from 200 to 50 000. The choice of polyisobutene radicals having certain molecular weights depends on the application medium and intended application of the particular phosphoric ester I according to the invention and is determined by those skilled in the art in the individual case.

Amphiphilic substances generally consist of a polar end group and a lipophilic tail. With the given end group (in the phosphoric esters according to the invention, this substantially corresponds to the R¹ radical), the lipophilicity of the compounds is substantially determined by the tail group (in I, this substantially corresponds to the R² radical). The molecular weight of this group generally correlates with the HLB value (hydrophilic lipophilic balance) of the compound and thus determines its suitability for specific applications for surface modification. The HLB value is a measure of the water and oil solubility of surface-active substances and of the stability of emulsions. Generally, substances having an HLB value of from 3 to 8 are suitable for use in W/0 emulsions, those having an HLB value of from 8.5 to 11 in W/0 microemulsions, those having an HLB value of from 7 to 9 as wetting agents, those having an HLB value of from 8 to 18 in 0/W emulsions, those having an HLB value of from 13 to 15 as detergents and those having an HLB value of from 12 to 18 as solubilizers (cf. Römpp Chemie-Lexikon, 9th edition, G. Thieme Verlag, p. 1812 and literature cited therein).

The use of the phosphoric ester according to the invention for hydrophilic modification of nonpolar surfaces such as polystyrene, polypropylene or polyethylene is subject to no strict requirements on the HLB value, so that polyisobutene radicals R² having a number-average molecular weight of from 500 to 50 000 are suitable here. If the phosphoric ester I according to the invention is to be used as a detergent or a dispersant in fuel and lubricant compositions, narrower HLB ranges are to be observed and accordingly polyisobutene radicals R² having a number-average molecular weight of from 100 to 3000 are suitable. Also when the phosphoric ester I according to the invention is used for lipophilic modification and/or for corrosion protection of polar surfaces, such as metal, glass and minerals, polyisobutene radicals having an Mₙ of from 100 to 3000 are suitable. This molecular weight range is also suitable for their use as emulsifiers, for example in W/o emulsions, 0/W emulsions or microemulsions.

For a given end group, the molecular weight of the tail group also generally correlates with the viscosity. In general, a relatively high molecular weight of a polymer within a polymer homolog series results in a relatively high viscosity of the solution which contains it (cf. Römpp Chemie-Lexikon, 9th edition, G. Thieme Verlag, p. 4939 and literature cited therein). Accordingly, for applications in which a ready miscibility or processibility of the phosphoric ester I according to the invention with the application medium is desired and therefore a low viscosity, for example in certain applications of the phosphoric ester I according to the invention in the printing sector, in lubricant compositions, as a plastics additive or in monolayers for surface modification of the coated material, polyisobutene radicals are selected which have relatively low molecular weights, in particular having an Mₙ of from 100 to 10 000, preferably from 100 to 1000. When a medium viscosity is desired, for example in certain applications of the phosphoric ester I according to the invention for stabilizing emulsions and dispersions or for surface modification of basic inorganic material, such as plaster, cement or calcium carbonate, polyisobutene radicals especially are selected which have an Mₙ of from 500 to 60 000, preferably from >1000 to 50 000, for example from >1000 to 10 000. When high viscosities of the application medium are desired, especially suitable are polyisobutene radicals having an Mₙ of from 2300 to 1 000 000, preferably from >10 000 to 100 000. With regard to further features of suitable and preferred polyisobutene radicals, reference is made to the remarks hereinbelow.

Moreover, R² is preferably a radical which is derived from “reactive” polyisobutenes which differ from “low-reactivity” polyisobutenes by the content of terminal double bonds. Reactive polyisobutenes differ from low-reactivity polyisobutenes in that they contain at least 50 mol %, based on the total number of polyisobutene macromolecules, of terminal double bonds. Particularly preferred R² radicals are derived from the reactive polyisobutenes having at least 60 mol % and in particular having at least 80 mol %, based on the total number of polyisobutene macromolecules, of terminal double bonds. The terminal double bonds may be either vinyl double bonds [—CH═C(CH₃)₂] (β-olefin) or vinylidene double bonds [—CH—C(═CH₂)—CH₃] (α-olefin). Preference is also given to the R² radical being derived from those polyisobutenes which have uniform polymer frameworks. Those polyisobutenes in particular which are composed of at least 85% by weight, preferably of at least 90% by weight and more preferably of at least 95% by weight, of isobutene units have uniform polymer frameworks. Moreover, the polyisobutene radical is derived from polyisobutenes having a polydispersity index (PDI) of preferably from 1.05 to 10. Polydispersity is the quotient of weight-average molecular weight M_{w} and of number-average molecular weight Mₙ (PDI=M_{w}/Mₙ). The choice of polyisobutene radicals having a certain PDI is determined by the application of the phosphoric ester according to the invention and is selected appropriately by those skilled in the art. At a given Mₙ, the PDI value of a compound or of a radical generally corresponds to its viscosity. Accordingly, for applications in which a ready miscibility or processability with the application medium and therefore a low viscosity are required, a polyisobutene radical is selected which has a PDI of preferably ≦3.0. However, for surface modifications in the form of coatings, a relatively high viscosity is frequently desired, so that in this case polyisobutene radicals having a PDI in the range from 1.5 to 10 are preferred. Phosphoric esters having a narrow molecular weight distribution (PDI from about 1.05 to about 2.0) of the polyisobutene radical are, for example, suitable for use of the phosphoric ester I in accordance with the invention as a detergent or dispersant in fuel and lubricant compositions, as an additive in printing systems, in polymers or in monolayers for hydrophobicization. Polyisobutene radicals having an average molecular weight distribution (PDI from about 1.6 to about 2.5) are suitable, for example, for use of the phosphoric ester I according to the invention in emulsions or dispersions and also for hydrophobicizing basic materials, such as calcium carbonate (for example in the form of mortar), plaster or cement, while those having a broad molecular weight distribution (PDI from about 2.1 to about 10) are suitable for use as corrosion inhibitors or likewise for hydrophobicizing basic materials. If the phosphoric esters I according to the invention are to be used as dispersants, especially in fuel and lubricant compositions, R² is derived from polyisobutenes having a PDI of preferably ≦3.0, more preferably ≦1.9, in particular ≦1.7 and especially ≦1.5.

Particularly preferred phosphoric esters according to the invention of the formula I are those in which a and b are each 1. In particular, the R² radical is arranged in the p-position of R¹.

The R³ radical is preferably C₁-C₁₀-alkyl, more preferably C₁-C₆-alkyl, in particular C₁-C₄-alkyl and especially methyl.

Especially in the case of use in fuel and lubricant compositions, preference is given to phosphoric esters of the formula I which contain no sulfur, i.e. in which neither R⁴ nor R⁵ are SR⁶ and in which R⁶ and R⁷ are not radicals which are interrupted by S and/or substituted by a sulfur-containing group, e.g. SR⁹.

The phosphoric ester I according to the invention is obtainable by customary prior art processes for preparing phosphoric esters. Such processes are described, for example, in Houben-Weyl, Methoden der organischen Chemie [Methods of organic chemistry], 4th edition, volume XII/2, pages 131 to 586 (1964) and also in volume E2, pages 487 to 780 (1982). These and the literature cited therein are fully incorporated by way of reference.

The present invention further provides a process for preparing the phosphoric ester of the formula I, by
a) reacting an aromatic hydroxyl compound of the formula V 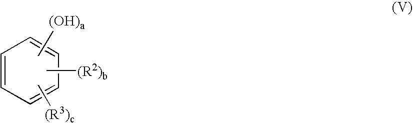
where R² and R³ and also a, b and c are each as defined above with a phosphorus oxide halide and
b) subsequently reacting the reaction product from step a) optionally with water, at least one alcohol, at least one thiol and/or at least one amine.

Preferred phosphorus oxide halides are phosphorus oxide chloride (POCl₃) and phosphorus oxide bromide (POBr₃), particular preference being given to phosphorus oxide chloride.

Polyisobutene-substituted aromatic hydroxyl compounds of the formula V and their preparation are disclosed, for example, by GB-A-1159368, U.S. Pat. No. 4,429,099, WO 94/14739, J. Polym. Sci. A, 31, 1938 (1993), WO 02/26840 and Kennedy, Guhaniyogi and Percec, Polym. Bull. 8, 563 (1970), which are fully incorporated herein by way of reference.

For instance, the polyisobutene-substituted aromatic hydroxyl compound of the formula V is obtainable, for example, by the reaction (alkylation) of an aromatic hydroxyl compound substituted by c R³ radicals with a polyisobutene.

Preferred aromatic hydroxyl compounds for the alkylation are unsubstituted and mono- or disubstituted phenol and also unsubstituted and mono- or disubstituted di- and trihydroxybenzenes. The hydroxyl groups in the di- and trihydroxyl compounds are preferably not in the o-position relative to one another. Particular preference is given to using phenols. Suitable substituted phenols are in particular mono-ortho-substituted phenols. Preferred substituents are C₁-C₄-alkyl groups, in particular methyl and ethyl. Particularly preferred for alkylation with polyisobutenes are unsubstituted phenol and 2-methylphenol. However, also suitable are optionally substituted di- and trihydroxybenzenes.

Useful polyisobutene in the alkylation reaction is any common and commercially available polyisobutene.

For the purposes of the present invention, the term “polyisobutene” also refers to oligomeric isobutenes, such as dimeric, trimeric or tetrameric isobutene.

For the purposes of the present invention, polyisobutenes are also all polymers obtainable by cationic polymerization which preferably contain at least 60% by weight of isobutene, more preferably at least 80% by weight, with greater preference at least 90% by weight and in particular at least 95% by weight, of polymerized isobutene. In addition, the polyisobutenes may contain further copolymerized butene isomers such as 1- or 2-butene, and also different olefinically unsaturated monomers which are copolymerizable with isobutene under cationic polymerization conditions.

Useful isobutene feedstuffs for the preparation of polyisobutenes which are suitable as reactants for the process according to the invention are accordingly both isobutene itself and isobutenic C₄-hydrocarbon streams, for example C₄ raffinates, C₄ cuts from isobutene dehydrogenation, C₄ cuts from steam crackers, FCC crackers (FCC: fluid catalyzed cracking), as long as they are substantially freed of 1,3-butadiene contained therein. Particularly suitable C₄-hydrocarbon streams generally contain less than 500 ppm, preferably less than 200 ppm, of butadiene. When C₄ cuts are used as starting material, the hydrocarbons other than isobutene assume the role of an inert solvent.

Useful copolymerizable monomers include vinylaromatics such as styrene and α-methylstyrene, C₁-C₄-alkylstyrenes such as 2-, 3- and 4-methylstyrene, and also 4-tert-butylstyrene, isoolefins having from 5 to 10 carbon atoms such as 2-methylbutene-1, 2-methylpentene-1,2-methylhexene-1,2-ethylpentene-1, 2-ethylhexene-1 and 2-propylheptene-1. Other useful comonomers include olefins which have a silyl group, such as 1-trimethoxysilylethene, 1-(trimethoxysilyl)propene, 1-(trimethoxysilyl)-2-methylpropene-2, 1-[tri(methoxyethoxy)silyl]ethene, 1-[tri(methoxyethoxy)silyl]propene, and 1-[tri(methoxyethoxy)silyl]-2-methylpropene-2.

Suitable polyisobutenes are all polyisobutenes obtainable by common cationic or living cationic polymerization. However, preference is given to “reactive” polyisobutenes which have already been described above.

Suitable polyisobutenes are, for example, the Glissopal brands from BASF-AG, for example Glissopal 550, Glissopal 1000 and Glissopal 2300, and also the Oppanol brands from BASF AG, such as Oppanol B10, B12 and B15.

Processes for preparing suitable polyisobutenes are known, for example from DE-A 27 02 604, EP-A 145 235, EP-A 481 297, EP-A 671 419, EP-A 628 575, EP-A 807 641 and WO 99/31151. Polyisobutenes which are prepared by living cationic polymerization of isobutene or isobutenic monomer mixtures are described, for example, in U.S. Pat. No. 4,946,899, U.S. Pat. No. 4,327,201, U.S. Pat. No. 5,169,914, EP-A 206 756, EP-A 265 053, WO 02/48216 and in J. P. Kennedy, B. Ivan, “Designed Polymers by Carbocationic Macromolecular Engineering”, Oxford University Press, New York 1991. These and other publications which describe polyisobutenes are fully incorporated herein by way of reference.

Depending on the polymerization process, the polydispersity index (PDI=M_{w}/Mₙ) of the polyisobutenes obtained is from about 1.05 to 10. Polymers from living cationic polymerization generally have a PDI of from about 1.05 to 2.0. The molecular weight distribution of the polyisobutenes used in the process according to the invention has a direct influence on the molecular weight distribution of the phosphoric ester according to the invention. As already detailed, depending on the application of the phosphoric ester according to the invention, polyisobutenes having a low, an average or a broad molecular weight distribution are selected.

The alkylation is preferably effected in the presence of a suitable catalyst. Suitable alkylation catalysts are, for example, protic acids such as sulfuric acid, phosphoric acid and organic sulfonic acids, e.g. trifluoromethanesulfonic acid, Lewis acids such as aluminum trihalides, e.g. aluminum trichloride or aluminum tribromide, boron trihalides, e.g. boron trifluoride and boron trichloride, tin halides, e.g. tin tetrachloride, titanium halides, e.g. titanium tetrabromide and titanium tetrachloride; and iron halides, e.g. iron trichloride and iron tribromide. The Lewis acids are optionally used together with Lewis bases, such as alcohols, in particular C₁-C₆-alkanols, phenols or aliphatic or aromatic ethers, for example diethyl ether, diisopropyl ether or anisole. Preference is given to adducts of boron trihalides, in particular boron trifluoride, in combination with the abovementioned Lewis bases. Particular preference is given to boron trifluoride etherate and boron trifluoride phenolate. For practical reasons, the latter is particularly suitable, since it is formed when boron trifluoride is introduced into the phenolic reaction mixture.

The alkylation product can subsequently be used in the process according to the invention crude or preferably purified. For purification, the reaction mixture can be freed of excess phenol and/or catalyst by, for example, extraction with solvents, preferably polar solvents, such as water or C₁-C₆-alkanols or mixtures thereof, by stripping, i.e. by passing through steam or optionally heating of gases, e.g. nitrogen, distillatively or using basic ion exchangers, as described in the German patent application P 10060902.3.

Preference is given to reacting the aromatic hydroxyl compound V with a phosphorus oxide halide in step a) in the presence of a suitable catalyst. Suitable catalysts are, for example, metal salts, in particular metal halides, such as magnesium chloride, calcium chloride, aluminum chloride, sodium chloride, potassium chloride, iron(III) chloride and zinc chloride. It is also possible to use metals and/or metal oxides, such as magnesium, calcium, aluminum or magnesium oxide, or alkali metal phenoxides, such as sodium phenoxide or potassium phenoxide. These generally react in reaction medium to give the corresponding halides. Phosphorus pentachloride also accelerates the reaction.

The choice of preferred catalysts is dependent upon which reaction product is to be obtained with preference in the reaction in step a). This is considered in detail hereinbelow.

The catalyst is preferably used in an amount of from 0.1 to 10 mol %, more preferably from 0.5 to 2 mol %, based on the hydroxyl compound II used.

Alternatively or supplementarily to the use of the abovementioned catalysts, the reaction in step a) can also be effected in the presence of a tertiary amine. Suitable tertiary amines are, for example, aliphatic amines such as triethylamine, tripropylamine or ethyldiisopropylamine, aromatic amines such as N,N-dimethylaniline, and heterocyclic amines such as pyrrole, pyridine, 2,6-dimethylpyridine, 2,6-tert-butylpyridine, quinoline, DBU and DBN.

The tertiary amine is preferably used in an amount of from 50 to 200 mol %, more preferably from 90 to 130 mol %, based on the aromatic hydroxyl compound II. The use of the tertiary amine in the reaction in step a) depends on which reaction product is to be obtained. This is illustrated in detail hereinbelow.

The reaction is preferably effected in a suitable solvent. Suitable solvents are aprotic solvents, for example aliphatic hydrocarbons such as pentane, hexane, heptane, octane, cyclohexane or cyclooctane, chlorinated aliphatic hydrocarbons such as methylene chloride, chloroform, carbon tetrachloride, di- or trichloroethane, aromatic hydrocarbons such as benzene, toluene, xylene, nitrobenzene or chlorobenzene, ethers such as diethyl ether, dipropyl ether, diisopropyl ether or tert-butyl methyl ether, cyclic ethers such as tetrahydrofuran or dioxane, ketones such as acetone or methyl ethyl ketone, carboxylic acid derivatives such as ethyl acetate, methyl acetate or N,N-dimethylformamide, dimethyl sulfoxide or mixtures of these solvents. Preferred solvents are aliphatic hydrocarbons, in particular hexane, chlorinated aliphatic hydrocarbons, in particular methylene chloride and chloroform, and aromatic hydrocarbons, in particular toluene.

The reaction temperature in the reaction in step a) depends, among other factors, on whether solvents are used, whether the reaction is effected in the presence of a catalyst and/or of a tertiary amine, and how reactive the hydroxyl compounds V used are. Generally, the reaction temperature required in a reaction which is effected without solvent and in particular without catalyst and/or tertiary amine is higher than in the presence thereof. When the reaction is effected in a solvent, the reaction temperature is also determined by the boiling point of the solvent used. The reaction temperature is preferably from 20 to 160° C., more preferably from 40 to 110° C., in particular from 60 to 105° C. and especially from 80 to 100° C.

Among other factors, the reaction time is dependent upon the reaction temperature, the reactivity of the reactants and the batch size, and is determined in the individual case by those skilled in the art.

The molar ratio in which the aromatic hydroxyl compound V and the phosphorus oxide halide are advantageously used depends in particular on which reaction products are to be obtained in step a). It depends also on the hydroxyl compound used, in particular on whether the hydroxyl compound V is a monohydric phenol (a=1) or a di-(a=2) or trihydroxyl compound (a=3).

In principle, three products are obtainable when phenols (a=1) are used in step a), i.e. a phosphoric monoester dihalide (in formula I: R⁴, R⁵=halogen), a phosphoric diester halide (R⁴=group of the formula III; R⁵=halogen) or a phosphoric triester (R⁴, R⁵=group of the formula III) which are formed in a formal sense by exchange of one, two and three halogen atoms respectively of the phosphorus oxide halide by the aromatic hydroxyl compound.

When a phosphoric monoester dihalide is mainly to be obtained in step a), the phosphorus oxide halide is generally used in an at least equimolar amount, but preferably in excess. The molar ratio of phenol V to phosphorus oxide halide is preferably from 1:1.1 to 1:5, more preferably from 1:1.2 to 1:3, in particular from 1:1.3 to 1:2 and especially about 1:1.5.

When a phosphoric triester is mainly to be obtained in step a), the phenol V can advantageously be used in excess. The molar ratio of phosphorus oxide halide to phenol V is preferably from 1:2.5 to 1:5, more preferably from 1:2.8 to 1:4 and in particular about 1:3.

Phosphoric diester halides are in principle formed in a mixture with phosphoric monoester dihalides and phosphoric triesters. However, they are formed in better yields when phenol V and phosphorus oxide halide are used in a ratio of about 2:1.

When a phosphoric diester halide or a phosphoric triester are to be obtained as the reaction product, preference is given to carrying out the reaction in the presence of a tertiary amine and optionally of one of the abovementioned catalysts.

To prepare phosphoric diester halides, the catalysts used are preferably magnesium, magnesium oxide or magnesium chloride.

To prepare phosphoric triesters, the catalysts used are preferably magnesium, calcium, aluminum, magnesium chloride, calcium chloride, aluminum chloride, iron(III) chloride, magnesium oxide or zinc chloride.

When the reaction product to be obtained is mainly a phosphoric monoester dihalide, preference is given to using no tertiary amine. A preferred catalyst in this case is aluminum trichloride.

Preference is given to carrying out the reaction of phenol and phosphorus oxide halide in step a) in such a way that the product obtained is mainly a phosphoric monoester dihalide.

When a polyhydric aromatic hydroxyl compound V (a=2 or 3) is used in step a), complex product mixtures are generally obtained, especially when the phenol is not used in large excess.

When both hydroxyl groups in dihydroxyl compounds are to be phosphorylated, the hydroxyl compound and the phosphorus oxide halide are used in a molar ratio of preferably from 1:2 to 1:4, more preferably from 1:2.2 to 1:3 and in particular from 1:2.5 to 1:3. When only one hydroxyl group is to be phosphorylated, the hydroxyl compound and the phosphorus oxide halide are preferably used in a ratio of 1:1.1 to 1:2, more preferably from 1:1.2 to 1:1.8, in particular from 1:1.3 to 1:1.7 and especially about 1:1.5. However, it is in this case advantageous to protect the hydroxyl group which is not to be phosphorylated from the reaction, for example by acetylation or by esterification with benzoic acid.

When trihydroxyl compounds are used and all three hydroxyl groups are to be phosphorylated, the molar ratio of aromatic hydroxyl compound to phosphorus oxide halide is preferably from 1:3 to 1:6, more preferably from 1:3.2 to 1:5 and in particular from 1:3.5 to 1:4.

The reaction in step a) is generally effected in such a way that the phosphorus oxide halide, the aromatic hydroxyl compound V and any catalyst and/or tertiary amine are optionally initially charged in a solvent and heated to the suitable reaction temperature. Alternatively, the phosphorus oxide halide and any catalyst and/or tertiary amine can also optionally be initially charged in a solvent and the aromatic hydroxyl compound V which is optionally present in a solvent can be added all at once or preferably gradually, and heating to the suitable reaction temperature is effected even before the addition, during or else only after completed addition. This procedure is preferred in particular when a phosphorus monoester dihalide is to be obtained as the reaction product. However, when a phosphoric triester is to be formed, preference is given to initially charging the aromatic hydroxyl compound V, any catalyst and/or tertiary amine, optionally in a solvent, and gradually adding the phosphorus oxide halide.

In the absence of a tertiary amine or of another acid scavenger, gas evolution generally occurs after an induction phase which can be attributed to the formation of hydrogen halide. The hydrogen halide can be removed during the reaction and optionally scavenged, which can be effected, for example, by introduction into a dilute aqueous basic solution, such as sodium hydroxide solution. The hydrogen halide is removed from the reaction mixture, for example, distillatively, for example by means of a slightly reduced pressure, or by introducing a gentle inert gas stream. The removal of hydrogen halide is also supported by the use of solvents in which it is only sparingly soluble, if at all, for example aliphatic, aromatic or chlorinated hydrocarbons.

After the end of the reaction which is frequently to be recognized by the ending of hydrogen halide development, preference is given to removing any excess phosphorus oxide halide and solvent present, which is effected, for example, distillatively, optionally under reduced pressure.

The reaction product from step a), especially when it is a phosphoric ester mono- or dihalide, preferably without further purification, is either put to its intended use or, if desired, used in step b).

Quite generally, the reactions in step b) are to be conducted in such a way that at least one of the ester groups of the phosphoric ester from step a) is not hydrolyzed.

The reaction of phosphoric monoester dihalides of phenols (a=1) with water generally leads even at low temperatures to the phosphoric monoester. Preference is given to carrying out the reaction at a temperature of from 10° C. to 100° C., more preferably from 40° C. to 80° C. The phosphoric monoester dihalide and water are used in a molar ratio of preferably from 1:1.7 to 1:10, more preferably from 1:2 to 1:3. Instead of water, it is also possible to use dilute aqueous basic or acid solutions. Suitable bases are, for example, alkali metal hydroxides such as sodium or potassium hydroxide, alkaline earth metal hydroxides such as magnesium, calcium or barium hydroxide, and ammonium hydroxides, alkali metal hydrogen carbonates such as sodium hydrogen carbonate, and alkali metal carbonates such as sodium carbonate. Suitable acids are, for example, mineral acids such as hydrochloric acid, hydrobromic acid, phosphoric acid and sulfuric acid, and preference is given to hydrochloric acid. The reaction is generally effected in such a way that the phosphoric monoester dihalide is initially charged in a suitable solvent, admixed with the water or the aqueous solution and optionally heated. Suitable solvents are the aprotic solvents described for the reaction in step a). On completion of the reaction, the product is advantageously freed of excess water, hydrogen halide and solvent, which is effected, for example, distillatively or, for example when using a water-immiscible solvent, by removing the aqueous phase in which the majority of the hydrogen halide formed or the salts which are formed when basic solutions are used is dissolved and removing the solvent distillatively.

The reaction of phosphoric diester halides with water generally leads to phosphoric diesters and usually entails rather more severe reaction conditions, for example higher reaction temperatures and/or longer reaction times. The reaction is generally accelerated by the use of basic aqueous solutions. Suitable bases are those mentioned above. It is also advantageous to carry out the reaction in a homogeneous system, for example in a water-miscible solvent as reaction medium. Suitable water-miscible solvents are, for example, cyclic ethers such as tetrahydrofuran and dioxane, and ketones such as acetone and methyl ethyl ketone. The reaction is preferably carried out at a temperature of from 30 to 100° C., more preferably from 50 to 100° C. The molar ratio of diester to water is preferably from 1:0.8 to 1:5, more preferably from 1:1 to 1:1.5. The reaction is preferably not carried out with an acidic aqueous solution, since the diesters formed are acid-sensitive. Basic solutions can also hydrolytically attack the diester, so that preference is given to working with calculated amounts of base. The workup is generally effected as described in the reaction of phosphoric monoester dihalides.

Phosphoric triesters can easily be hydrolyzed with water or dilute basic aqueous solutions to give the phosphoric diesters and monoesters, although the hydrolysis can also proceed up to the stage of phosphoric acid. Accordingly, preference is given to reacting the triesters with a calculated amount of bases or of water, in order to stop the hydrolysis at the stage of the mono- or diesters.

The reaction of polyphosphorylated di- and trihydroxyl compounds with water usually proceeds up to the stage of phosphoric acid, so that these are preferably not reacted with water.

The phosphoric monoester dihalides can also be reacted with one or more alcohols. Depending on the molar ratio of the reactants, the reaction leads to different products. For instance, the reaction with an approximately equimolar amount of an alcohol leads substantially to the mixed phosphoric diester halide. This can subsequently be hydrolyzed as described above to give the mixed phosphoric diester or reacted with a further alcohol to give a mixed phosphoric triester having three different ester groups. Also, the phosphoric diester halide can be reacted with an amine to give a mixed phosphoric diester monoamide or with a thiol to give a mixed phosphoric (O,O,S)-triester. The reaction of the phosphoric monoester dihalide with at least two moles of an alcohol generally leads directly to the mixed phosphoric triester. Especially in the reaction to give the triester, preference is given to working in the presence of tertiary amines. Suitable tertiary amines are those mentioned above. Suitable alcohols are those having from 1 to 20 carbon atoms and from 1 to 4 hydroxyl groups, such as methanol, ethanol, propanol, isopropanol, butanol, isobutanol, tert-butanol, pentanol, hexanol, cyclohexanol, heptanol, octanol, 2-ethylhexanol, nonanol, decanol, undecanol, dodecanol, tridecanol, tetradecanol, pentadecanol, hexadecanol, heptadecanol, octadecanol, nonadecanol and eicosyl alcohol, and also their positional isomers, and in addition ethylene glycol, 1,3-propylene glycol, 1,4-butylene glycol, glycerol, trimethylolpropane and pentaerythritol. Also suitable are polyether polyols of the formula VI.a
HO [symbol] (CR^{1l}R¹²)ₖ(CR¹³R¹⁴)ₘ—O [symbol] ₗ—(CR¹¹R¹²)ₖ(CR¹³R¹⁴)ₘ—OR¹⁶ (VI.a)
where R¹¹ to R¹⁴, R¹⁶, k, l and m are each as defined in formula IV. R¹¹ and R¹³ are preferably each H, and R¹² and R¹⁴ are preferably each H or C₁-C₄-alkyl, in particular H or methyl and especially H. k and m are preferably each a number from 1 to 3 and in particular 1. The sum of k and m is preferably a number from 2 to 4, in particular 2. l is preferably a number from 1 to 600, more preferably from 1 to 40, in particular from 1 to 10 and especially from 1 to 4. Particularly preferred polyether polyols are di-, tri-, tetra- and pentaethylene glycol (m, k=1, l=1 to 4, R¹¹ to R¹⁴ and R¹⁶=H) and also their monomethyl or monoethyl ethers (R¹⁶=methyl or ethyl). Preference is also given to polyethylene glycols which have an Mₙ of from 280 to 15 000, for example of about 300, 400, 500, 700, 1000, 1500, 2000, 3000, 4000, 5000, 7000, 8000, 10 000 or 12 000.

Particularly preferred alcohols are those having only one hydroxyl group, i.e. either monools or polyols, in which the remaining hydroxyl functions are etherified.

Also suitable are aromatic hydroxyl compounds such as optionally substituted phenols, naphthols or benzyl alcohols. Suitable substituted aromatic alcohols are those which have from 1 to 3 substituents selected from halogen, C₁-C₆-alkyl and C₁-C₆-alkoxy.

Instead of the alcohols, it is also possible to use the corresponding alkoxides in step b). These may be used as such or generated in situ. Suitable alkoxides are the corresponding alkali metal, alkaline earth metal, heavy metal and ammonium alkoxides, and preference is given to the alkali metal alkoxides, in particular the sodium or potassium alkoxides, and also to the ammonium alkoxides.

The reaction is preferably effected in a suitable solvent. Suitable solvents are the aprotic solvents specified for the reaction in step a). Additionally suitable are also the alcohols themselves and also their mixtures with these solvents, if the phosphoric monoester dihalide is to be converted directly to the phosphoric triester and if the alcohols used can be removed again on completion of reaction.

The reaction temperature is preferably from 0 to 70° C., in particular from 0 to 50° C. The reaction of the phosphoric monoester dihalide with the alcohol is effected in such a way that, for example, the dihalide and any tertiary amine are initially charged in a solvent and subsequently admixed with the alcohol. On completion of the reaction, the reaction mixture is worked up by customary methods, for example by distillative or extractive removal of the solvent, of any excess alcohol and tertiary amine or its reaction product.

In a similar manner to the phosphoric monoester dihalides, the phosphoric diester halides can be converted to the mixed triesters. The remarks made in the case of the phosphoric monoester dihalides with regard to suitable alcohols and reaction conditions apply here correspondingly.

Phosphoric triesters can be transesterified with one or two different alcohols to give mixed phosphoric triesters under the above-described reaction conditions.

Depending on the molar ratio of the reactants, phosphoric monoester dihalides can be reacted with ammonia, primary or secondary amines to give different products. For instance, the reaction with two equivalents of an amine leads to phosphoric monoester monoamide halides. These can subsequently either be hydrolyzed as described above to give phosphoric monoester monoamides, be reacted with an alcohol as described above to give mixed phosphoric diester monoamides or be reacted with a further amine to give a mixed phosphoric ester diamide. When at least four equivalents of an amine are used, phosphoric monoester diamides are obtained directly.

Suitable primary amines are both mono- and polyamines having from 1 to 20 carbon atoms. Primary amines are amines NR^{a}R^{b}R^{c}, in which two of the R^{a}, R^{b} or R^{c} radicals are H.

Examples of suitable primary monoamines are methylamine, ethylamine, propylamine, butylamine, pentylamine, hexylamine, heptylamine, octylamine, 2-ethylhexylamine, nonylamine, decylamine, undecylamine, dodecylamine, tridecylamine, tetradecylamine, pentadecylamine, hexadecylamine, heptadecylamine, octadecylamine, nonadecylamine, eicosylamine and also cyclooctylamine and cyclodecylamine. Preferred primary monoamines are methylamine, ethylamine, propylamine, butylamine, pentylamine, hexylamine, 2-ethylhexylamine and cyclohexylamine.

Also suitable are hydroxy- or alkoxy-substituted amines, such as 2-hydroxyethylamine, 2-methoxyethylamine, 2-ethoxyethylamine, 3-hydroxypropylamine, 3-methoxypropylamine and 3-ethoxypropylamine and the like.

Also suitable are primary aromatic amines such as aniline.

Suitable primary polyamines are those of the formula VI.b
H₂N [symbol] (CR¹¹R¹²)ₖ(CR¹³R¹⁴)ₘ—NR¹⁵ [symbol] ₗ—(CR¹¹R¹²)ₖ(CR¹³R¹⁴)ₘ—NR¹⁶R¹⁷ (VI.b)
where R¹¹ to R¹⁷ and also k and m are each as defined in formula IV and l is a number from 0 to 1000.

R¹¹ and R¹³ are preferably each H. R¹² and R¹⁴ are preferably each H or C₁-C₄-alkyl, in particular H or methyl and especially H. R¹⁵ is preferably H. k and m are preferably each a number from 1 to 3, in particular 1. l is preferably a number from 0 to 100, more preferably from 0 to 40, in particular from 0 to 10 and especially from 0 to 4. R¹⁶ and R¹⁷ are preferably each H. Particularly preferred primary polyamines are diethylenetriamine, triethylenetetramine, tetraethylenepentamine, pentaethylenehexamine, 3-N,N-dimethylaminopropylamine and 3-N,N-diethylaminopropylamine.

Suitable secondary amines are both mono- and polyamines having from 1 to 20 carbon atoms. Secondary amines are amines NR^{a}R^{b}R^{c}, in which only one of the radicals R^{a}, R^{b} or R^{c} is H.

Suitable secondary monoamines are, for example, dimethylamine, diethylamine, dipropylamine, diisopropylamine, dibutylamine, diisobutylamine, di-tert-butylamine, dipentylamine, dihexylamine, diheptylamine, dioctylamine, di(2-ethylhexyl)amine, dinonylamine and didecylamine, and also N-methylcyclohexylamine, N-ethylcyclohexylamine and dicyclohexylamine. Preferred secondary monoamines are dimethylamine, diethylamine, dipropylamine, diisopropylamine, dibutylamine, diisobutylamine, di-tert-butylamine, dipentylamine, dihexylamine, di(2-ethylhexyl)amine and dicyclohexylamine.

Also suitable are hydroxy- or alkoxy-substituted secondary amines, such as bis(2-hydroxyethyl)amine, bis(2-methoxyethyl)amine and bis(2-ethoxyethyl)amine.

Also suitable are secondary aromatic amines, such as N-methylaniline or diphenylamine.

Suitable secondary polyamines are those of the formula
NHR¹⁸R¹⁹
where

R¹⁸ is a radical of the formula VII [symbol]
(CR¹¹R¹²)ₖ(CR¹³R¹⁴)ₘ—NR¹⁵ [symbol] ₗ—(CR¹¹R¹²)ₖ(CR¹³R¹⁴)ₘ—NR¹⁶R¹⁷ (VII)
where
R¹¹ to R¹⁵ and also k and m are as defined in formula IV,
R¹⁶ is C₁-C₆-alkyl,
R¹⁷ is H or C₁-C₆-alkyl and
l is a number from 0 to 1000 and

R¹⁹ is C₁-C₆-alkyl or a radical of the formula VII.

In formula VII, R¹¹ and R¹³ are preferably each H. R¹² and R¹⁴ are preferably each H or C₁-C₄-alkyl, in particular H or methyl and especially H. R¹⁵ is preferably H. k and m are preferably each a number from 1 to 3, in particular 1. l is preferably a number from 0 to 100, more preferably from 0 to 40, in particular from 0 to 10 and especially from 0 to 4. R¹⁶ is preferably C₁-C₄-alkyl. R¹⁷ is preferably H or C₁-C₄-alkyl. Particularly preferred secondary polyamines are bis(3-N,N-dimethylaminopropyl)amine and bis(3-N,N-diethylaminopropyl)amine.

Preference is given to using primary amines in the process according to the invention, in particular primary polyamines.

The reaction is preferably carried out in a suitable solvent. Suitable and preferred solvents are the solvents specified for the reaction of phosphoric monoester dihalides with an alcohol, apart from the alcohols.

The reaction is preferably effected at a temperature of from −30° C. to 100° C., more preferably from −20° C. to 50° C.

In a similar manner to the phosphoric monoester dihalides, the phosphoric diester monohalides can be reacted with at least two equivalents of an amine or ammonia to give phosphoric diester amides.

The phosphoric monoester dihalides can also be reacted with one or more thiols. Depending on the molar ratio of the reactants, the reaction leads to different products. For instance, the reaction with an approximately equimolar amount of a thiol leads to the phosphoric (O,S)-diester halide. As described above, this can subsequently be hydrolyzed to give the mixed phosphoric (O,S)-diester or reacted with a further alcohol to give a mixed phosphoric (O,O,S)-triester or with a further thiol to give a mixed phosphoric (O,S,S)-triester or else with an amine to give a phosphoric (O,S)-diester amide. The reaction of the phosphoric monoester dihalide with at least two moles of a thiol generally leads directly to the phosphoric (O,S,S)-triester. The reaction is preferably effected in the presence of a tertiary amine. Suitable tertiary amines are those mentioned above.

Suitable thiols are those having from 1 to 20 carbon atoms, such as methylthiol, ethylthiol, propylthiol, butylthiol, pentylthiol, hexylthiol, heptylthiol, octylthiol, nonylthiol or decylthiol, and also the higher homologs and positional isomers. Also suitable are polythioether polythiols of the formula VI.c
HS [symbol] (CR¹¹R¹²)ₖ(CR¹³R¹⁴)ₘ—S [symbol] ₗ—(CR¹¹R¹²)ₖ(CR¹³R¹⁴)ₘ—SR¹⁶ (VI.c)
where R¹¹ to R¹⁶ and also k, l and m are each as defined in formula IV.

R¹¹ and R¹³ are preferably each H. R¹² and R¹⁴ are preferably each H or C₁-C₄-alkyl, in particular H or methyl and especially H. k and m are preferably each a number from 1 to 3, in particular 1. l is preferably a number from 1 to 10, in particular from 1 to 4. Suitable polythioether polythiols are both dithiols (R¹⁶=H), and also their monothioethers (R¹⁶=C₁-C₆-alkyl).

Also suitable are aromatic thiols, for example thiophenol itself and also thiophenols which bear from 1 to 3 substituents selected from halogen, C₁-C₆-alkyl and C₁-C₆-alkoxy.

Preference is given to carrying out the reaction in a suitable solvent. Suitable and preferred solvents are the solvents specified for the reaction of phosphoric monoester dihalide with an alcohol, apart from the alcohols.

The reaction is preferably effected at a temperature of from −20° C. to 100° C., more preferably from 10° C. to 70° C.

Phosphoric (O,O)- or (O,S)-diesters and also phosphoric monoester monoamides and phosphoric monoesters can in turn be derivatized. For example, they can be derivatized to the corresponding salts by reaction with alkali metal and ammonium hydroxides or carbonates, with alkaline earth metal carbonates and also with heavy metal carbonates or acetates. The heavy metal salts, in particular the lead and silver salts, can be converted to the corresponding esters by reaction with an alkyl or aryl halide. They can also be reacted with diazoalkanes or with dimethyl sulfoxide to give corresponding esters.

The phosphoric ester mono- or dihalides can also be converted to other phosphoric halides by means of halogen exchange. For example, a phosphoric ester mono- or dichloride can be converted to the corresponding phosphoric fluoride by reaction with an alkali metal fluoride, zinc fluoride, sodium hexafluorosilicate, antimony(III) fluoride or hydrogen fluoride.

The phosphoric esters of the formula I according to the invention are also obtainable by other processes. For example, the aromatic hydroxyl compounds of the formula V can be reacted with phosphoric acid, optionally in the presence of a carbodiimide or in the presence of trichloroacetonitrile, to give the corresponding phosphoric mono- and optionally diesters. These can be converted to the corresponding phosphoric monoester dihalides or phosphoric diester monohalides, for example, by reaction with a phosphorus oxide halide or with a phosphorus pentahalide, and these can in turn be further derivatized as described above. The phosphoric monoesters or the phosphoric diesters can also be reacted directly with alcohols or alkoxides to give phosphoric di- or triesters. In addition, the phosphoric monoesters or the phosphoric diesters can be reacted with bases to give the corresponding salts. The mono- or diesters can react with amines to give the corresponding phosphoric monoester monoamides, phosphoric monoester diamides or phosphoric diester monoamides. The phosphoric mono- or diesters can also be reacted with thiols to give phosphoric di-(O,S)-esters, phosphoric tri-(O,S,S)-esters or phosphoric tri-(O,O,S)-esters. All esters and amides can in turn be converted by partial hydrolysis to phosphoric monoesters, phosphoric diesters, phosphoric monoester monoamides and the corresponding thioesters, and also salts thereof. The aromatic hydroxyl compounds of the formula V can also be converted to the corresponding phosphoric monoester dihalides by reaction with a phosphorus pentahalide or with a pyrophosphoryl halide, and these can subsequently be further derivatized as already illustrated. Overall, the particular phosphoric acid derivatives can be further derivatized in a variety of ways.

The present invention further provides a phosphoric ester-containing composition obtainable by
a) reacting an aromatic hydroxyl compound of the formula V 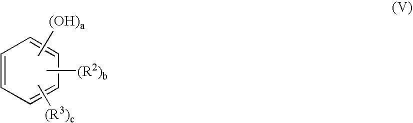
where R² and R³ and also a, b and c are each as defined above with a phosphorus oxide halide and
b) subsequently reacting the reaction product from step a) optionally with water, at least one alcohol, at least one thiol and/or at least one amine.

With regard to suitable aromatic hydroxyl compounds V, phosphorus oxide halides, alcohols, amines, thiols, suitable and preferred procedures, the same applies as above.

In a preferred embodiment, no thiol is used in step b).

The phosphoric ester-containing composition preferably contains at most 1000 ppm, more preferably at most 50 ppm and in particular at most 5 ppm, of phosphoric esters which contain thioester groups (i.e. R⁴ and/or R⁵=SR⁶).

In particular, the phosphoric ester-containing composition contains a total of at most 20 mol %, more preferably at most 10 mol % and in particular at most 5 mol %, of sulfur-containing compounds.

In addition to the above-described phosphoric ester I, the phosphoric ester-containing composition according to the invention optionally comprises further reaction products which result from the preparation process. These include, for example, phosphoric ester imides, esters of polyesterified polyols, cyclic esters when di- and trihydroxyl compounds are used as the reactant of the formula V and many others. This composition which may consist of several components is suitable for numerous applications and does not need to be converted to the pure phosphoric ester I by costly and inconvenient isolation.

The present invention further provides the use of at least one phosphoric ester I according to the invention or of a phosphoric ester-containing composition according to the invention for surface modification of organic or inorganic material, as a hydrophilicizing agent, lipophilicizing agent, corrosion inhibitor, friction modifier, emulsifier, dispersant, adhesion promoter, wetting agent or wetting inhibitor. The remarks made above on the phosphoric ester I according to the invention and on the phosphoric ester-containing composition according to the invention apply here correspondingly. The choice of suitable phosphoric esters I is determined specifically by the particular application and application medium and can be determined by those skilled in the art in each individual case.

Organic materials suitable for surface modification with the phosphoric ester I according to the invention are, for example, plastics, in particular polyolefins, such as polyethylene, polypropylene, polyisobutene and polyisoprene, and polyaromatics such as polystyrene, and also copolymers and mixtures thereof, and the plastics are preferably in the form of films or shaped bodies, cellulose, for example in the form of paper or cardboard, textiles of natural or synthetic fibers, leather, wood, mineral oil products such as combustion fuels, motor fuels or lubricants, and additives for such mineral oil products, such as lubricity improvers and cold flow improvers. Suitable inorganic materials are, for example, inorganic pigments, metal, glass and basic inorganic materials, such as cement, gypsum or calcium carbonate.

For the purposes of the present invention, surface modification is the changing of the interface properties of the media admixed with the phosphoric esters I according to the invention or with the phosphoric ester-containing composition according to the invention. Phase interfaces are surfaces which separate two nonmiscible phases from each other (gas-liquid, gas-solid, liquid-solid, liquid-liquid, solid-solid). The interface properties include the sticking, adhesive or sealing action, the flexibility, resistance to scratching or breaking, the wettability and the wetting capability, lubricant properties, frictional force, corrodability, dyeability, printability and gas permeability of the application media. Accordingly, the phosphoric ester I according to the invention or the phosphoric ester-containing composition according to the invention are preferably used as hydrophilizing agents, lipophilizing agents (hydrophobizing agents), corrosion inhibitors, friction modifiers, emulsifiers, dispersants, adhesion promoters, wetting agents, wetting inhibitors, volatilizing agents or printing ink additives.

In a special embodiment, the inventive phosphoric esters are suitable for altering the affinity of a substrate surface for water and aqueous liquids in comparison to an unmodified surface. The phosphoric esters used in accordance with the invention for this purpose comprise firstly compounds which improve the affinity of a surface treated thereby for water (hydrophilize) and secondly those which reduce the affinity of a surface treated thereby for water (hydrophobize). A suitable measure for assessing the hydrophilicity/hydrophobicity of the surface of a substrate is the measurement of the contact angle of water on the particular surface (see, for example, Römpp, Chemielexikon, 9th ed., p. 372 “Benetzung” [Wetting], Georg-Thieme-Verlag (1995)). According to the invention, a “hydrophobic surface” refers to a surface whose contact angle of water is >90°. A “hydrophilic surface” refers to a surface whose contact angle of water is ≦90°. Hydrophilizing phosphoric esters bring about a reduction in the contact angle on surfaces treated with them compared to the unmodified surface. Phosphoric esters having a hydrophobizing action bring about an increase in the contact angle on surfaces treated with them compared to the unmodified surface.

The present invention also provides a fuel and lubricant additive comprising at least one phosphoric ester of the formula I according to the invention or one phosphoric ester-containing composition according to the invention. Preferred phosphoric esters are those in which the R⁴ and R⁵ radicals in the phosphoric acid radical R¹ are each independently OR⁶ or NR⁶R⁷. Preferred phosphoric ester-containing compositions are those which contain at most 1000 ppm, more preferably at most 500 ppm, in particular at most 100 ppm and especially at most 50 ppm, of sulfur-containing compounds. The remarks made above on the phosphoric ester I according to the invention and on the phosphoric ester-containing composition according to the invention apply here correspondingly.

The present invention further provides a fuel and lubricant composition comprising a main amount of a hydrocarbon fuel or of a lubricant and at least one phosphoric ester I according to the invention or one phosphoric ester-containing composition according to the invention and also optionally at least one further additive. The remarks made above on the phosphoric ester I according to the invention and on the phosphoric ester-containing composition according to the invention apply here correspondingly.

For the purposes of the present invention, the term “fuel” includes, in addition to the motor fuels in the actual sense, also combustion fuels such as heating oils. Useful motor fuels in the actual sense include all commercial gasoline and diesel fuels. Useful combustion fuels include all commercial heating oils.

Preferred phosphoric esters I in this case also are those in which R⁴ and R⁵ are each independently OR⁶ or NR⁶R⁷. Preferred phosphoric ester-containing compositions are those which contain at most 1000 ppm, more preferably at most 500 ppm, in particular at most 100 ppm and especially at most 50 ppm, of sulfur-containing compounds.

The fuel and lubricant compositions according to the invention preferably contain the phosphoric esters according to the invention in an amount of from 5 to 5000 ppm, more preferably from 10 to 1000 ppm and in particular from 20 to 500 ppm.

Finally, the present invention provides an additive concentrate comprising a phosphoric ester I according to the invention or a phosphoric ester-containing composition according to the invention and at least one diluent and optionally at least one further additive. In this case also, preferred phosphoric esters are those in which the R⁴ and R⁵ radicals in the phosphoric acid radical R¹ are each independently OR⁶ or NR⁶R⁷. Preferred phosphoric ester-containing compositions are those which contain at most 1000 ppm, more preferably at most 500 ppm, in particular at most 100 ppm and especially at most 50 ppm, of sulfur-containing compounds. The remarks made above on the phosphoric ester according to the invention and on the phosphoric ester-containing composition according to the invention apply here correspondingly. The phosphoric ester I is present in the additive concentrate according to the invention preferably in an amount of from 0.1 to 80% by weight, more preferably from 10 to 70% by weight and in particular from 30 to 60% by weight, based on the weight of the concentrate.

Suitable diluents are, for example, aliphatic and aromatic hydrocarbons, such as Solvent Naphtha. When the additive concentrates according to the invention are to be used in low-sulfur diesel or gasoline fuels, preference is given to low-sulfur hydrocarbons as diluents in the additive concentrate.

In addition to the phosphoric ester I or in addition to the phosphoric ester-containing composition according to the invention, the fuel and lubricant compositions and the additive concentrates according to the invention optionally comprise further customary fuel and lubricant additives, preferably the additives described hereinbelow:

Examples of additives which are used in the fuel and lubricant compositions according to the invention or in the concentrates are further additives having detergent action or having valve seat wear-inhibiting action, each of which has at least one hydrophobic hydrocarbon radical having a number-average molecular weight (Mₙ) of from 85 to 20 000 and at least one polar moiety, selected from

(a) mono- or polyamino groups having up to 6 nitrogen atoms in which at least one nitrogen atom has basic properties,

(b) hydroxyl groups in combination with mono- or polyamino groups in which at least one nitrogen atom has basic properties,

(c) carboxyl groups or their alkali metal or alkaline earth metal salts,

(d) polyoxy-C₂-C₄-alkylene moieties which are terminated by hydroxyl groups, mono- or polyamino groups, in which at least one nitrogen atom has basic properties, or are terminated by carbamate groups,

(e) carboxylic ester groups,

(f) moieties which are derived from succinic anhydride and have hydroxyl and/or amino and/or amido and/or imido groups and

(g) groups formed by conventional Mannich reaction of phenolic hydroxyl groups with aldehydes and mono- or polyamines.

Examples of the above additive components having detergent action include the following:

Additives containing mono- or polyamino groups (a) are preferably polyalkenemono- or polyalkenepolyamines based on polypropene or on highly reactive (i.e. having predominantly terminal double bonds, usually in the β- and γ-positions) or conventional (i.e. having predominantly internal double bonds) polybutene or polyisobutene having an M_{N} of from 600 to 5000. Such additives based on reactive polyisobutene, which can be prepared from the polyisobutene (which may contain up to 20% by weight of n-butene units) by hydroformylation and reductive amination with ammonia, monoamines or polyamines, such as dimethylaminopropylamine, ethylenediamine, diethylenetriamine, triethylenetetramine or tetraethylenepentamine, are disclosed in particular in EP-A 244 616. When polybutene or polyisobutene having predominantly internal double bonds (usually in the β- and γ-positions) are used as starting materials in the preparation of the additives, a possible preparative route is by chlorination and subsequent amination or by oxidation of the double bond with air or ozone to give the carbonyl or carboxyl compound and subsequent amination under reductive (hydrogenating) conditions. The amines used here for the amination may be the same as those used above for the reductive amination of the hydroformylated reactive polyisobutene. Corresponding additives based on polypropene are described in particular in WO-A 94/24231.

Further preferred additives containing monoamino groups (a) are the hydrogenation products of the reaction products of polyisobutenes having an average degree of polymerization P of from 5 to 100 with nitrogen oxides or mixtures of nitrogen oxides and oxygen, as described in particular in WO-A 97/03946.

Further preferred additives containing monoamino groups (a) are the compounds obtainable from polyisobutene epoxides by reaction with amines and subsequent dehydration and reduction of the amino alcohols, as described in particular in DE-A 196 20 262.

Additives containing hydroxyl groups in combination with mono- or polyamino groups (b) are in particular reaction products of polyisobutene epoxides, obtainable from polyisobutene having preferably predominantly terminal double bonds and an M_{N} of from 600 to 5000, with ammonia or mono- or polyamines, as described in particular in EP-A 476 485.

Additives containing carboxyl groups or their alkali metal or alkaline earth metal salts (c) are preferably copolymers of C₂-C₄₀-olefins with maleic anhydride, said copolymers having a total molar mass of from 500 to 20 000, some or all of whose carboxyl groups have been converted to the alkali metal or alkaline earth metal salts and the remainder of the carboxyl groups with alcohols or amines. Such additives are disclosed in particular by EP-A 307 815. Such additives can, as described in WO-A 87/01126, advantageously be used in combination with customary fuel detergents such as poly(iso)butenamines or polyetheramines.

Additives containing polyoxy-C₂- to C₄-alkylene groups (d) are preferably polyethers or polyetheramines which are obtainable by reaction of C₂- to C₆₀-alkanols, C₆- to C₃₀-alkanediols, mono- or di-C₂-C₃₀-alkylamines, C₁-C₃₀-alkylcyclohexanols or C₁-C₃₀-alkylphenols with from 1 to 30 mol of ethylene oxide and/or propylene oxide and/or butylene oxide per hydroxyl group or amino group and, in the case of the polyetheramines, by subsequent reductive amination with ammonia, monoamines or polyamines. Such products are described in particular in EP-A 310 875, EP-A 356 725, EP-A 700 985 and U.S. Pat. No. 4,877,416. In the case of polyethers, such products also have carrier oil properties. Typical examples of these are tridecanol butoxylates, isotridecanol butoxylates, isononylphenol butoxylates and polyisobutenol butoxylates and propoxylates and the corresponding reaction products with ammonia.

Additives containing carboxylic ester groups (e) are preferably esters of mono-, di- or tricarboxylic acids with long-chain alkanols or polyols, in particular those having a minimum viscosity of 2 mm² at 100° C., as described in particular in DE-A 38 38 918. The mono-, di- or tricarboxylic acids used may be aliphatic or aromatic acids, and particularly suitable ester alcohols or ester polyols are long-chain representatives having, for example, 6 to 24 carbon atoms. Typical representatives of the esters are adipates, phthalates, isophthalates, terephthalates and trimellitates of isooctanol, of isononanol, of isodecanol and of isotridecanol. Such products also have carrier oil properties.

Additives containing groups which are derived from succinic anhydride and have hydroxyl and/or amino and/or amido and/or imido groups (f) are preferably corresponding derivatives of polyisobutenylsuccinic anhydride which are obtainable by reacting conventional or reactive polyisobutene having an M_{N} of from 300 to 5000 with maleic anhydride by a thermal route or via the chlorinated polyisobutene. Of particular interest in this connection are derivatives with aliphatic polyamines such as ethylenediamine, diethylenetriamine, triethylenetetramine or tetraethylenepentamine. Such gasoline fuel additives are described in particular in U.S. Pat. No. 4,849,572.

Additives containing moieties (g) produced by conventional Mannich reaction of phenolic hydroxyl groups with aldehydes and mono- or polyamines are preferably reaction products of polyisobutene-substituted phenols with formaldehyde and primary mono- or polyamines, such as ethylenediamine, diethylenetriamine, triethylenetetramine, tetraethylenepentamine or dimethylaminopropylamine. Such polyisobutene Mannich bases are described in particular in EP-A 831 141, which is fully incorporated herein by way of reference.

For more precise definition of the individual detailed fuel additives, reference is explicitly made here to the abovementioned prior art documents.

Useful solvents or diluents (when preparing additive packages and concentrates) are the diluents specified above for the concentrates according to the invention, for example aliphatic and aromatic hydrocarbons, such as Solvent Naphtha.

Further customary additive components which can be combined with the phosphoric ester according to the invention are, for example, customary corrosion inhibitors, for example based on ammonium salts of organic carboxylic acids (said salts tending to form films) or on heterocyclic aromatics, antioxidants or stabilizers, for example based on amines such as p-phenylenediamine, dicyclohexylamine or derivatives thereof, or on phenols such as 2,4-di-tert-butylphenol or 3,5-di-tert-butyl-4-hydroxyphenyl-propionic acid, demulsifiers, antistats, metallocenes such as ferrocene or methylcyclopentadienylmanganese tricarbonyl, lubricity additives such as certain fatty acids, alkenylsuccinic esters, bis(hydroxylalkyl) fatty amines, hydroxyacetamides or castor oil and colorants (markers). Optionally, amines are also added to reduce the pH of the fuel.

Further customary components include carrier oils. These include, for example, mineral carrier oils (base oils), in particular those of the “solvent neutral (SN) 500 to 2000” viscosity class, synthetic carrier oils based on olefin polymers having an M_{N} of from 400 to 1800, in particular based on polybutene or polyisobutene (hydrogenated or nonhydrogenated), on poly-alpha-olefins or polyinternal olefins and also synthetic carrier oils based on alkoxylated long-chain alcohols or phenols. Likewise suitable as further additives are polyalkene alcohol-polyetheramines, as described, for example, in DE-199 16 512.2.

The present invention further provides a printing ink composition comprising at least one printing ink and at least one inventive phosphoric ester. The remarks made above with regard to suitable and preferred phosphoric esters apply here correspondingly.

Printing inks refer to solid, pasty or liquid colorant formulations which are used in printing machines. Suitable printing inks depend upon the particular printing process in which they are used, and upon the material to be printed.

The material to be printed may be either absorbent or nonabsorbent and be elongated in one dimension, for example in fiber form, in two dimensions (flat) or in three dimensions, for example cylindrically or conically. Flat materials are, for example, paper, cardboard, leather or films, for example plastics or metal films. Cylindrical or conical materials are, for example, hollow bodies, for example cans. Preferred materials are paper and plastics films. Suitable plastics are, for example, polyolefins such as polyethylene, polybutylene, polypropylene, polyisobutene and polyisoprene, and polyaromatics such as polystyrene, and also copolymers and mixtures thereof.

The inventive printing ink composition may be used in all common printing processes, for example relief printing such as letterpress printing and flexographic printing, planographic printing such as offset printing, lithographic printing and collotype printing, gravure printing such as rotogravure printing and steel plate printing, and also porous printing such as screenprinting, frame, film and stencil printing.

Suitable colorants are both pigments and dyes. Suitable pigments and dyes are all colorants which are customary in the particular printing process.

The inventive printing ink composition generally comprises a colorant composition customary for the particular printing process and an inventive phosphoric ester.

In addition to the colorant, customary colorant compositions generally comprise binders which are usually referred to as printing varnishes, and additives such as dessicants, diluents, wax dispersions and, if appropriate, catalysts or initiators for the radiative drying. The composition is selected specifically by the printing process, the substrate to be printed and the quality desired in the printing with regard to appearance such as gloss, opacity, hue and transparency, and physical properties such as water, fat and solvent resistance, rubbing resistance and lamination capacity.

For instance, suitable varnishes for pasty offset, letterpress and screenprinting inks consist, for example, of stand oils, phenol-modified rosins, mineral oils, linseed oil and/or alkyd resins (combination varnishes) or of hydrocarbon resins and rosins, asphalt and cyclo rubber (mineral oil varnishes). Suitable varnishes for flexographic, gravure and screenprinting inks are, for example, resin-solvent systems comprising collodium wool, polyamide resins, ketone resins, vinyl polymers, and maleate, phenol, amine, acrylic, polyester or polyurethane resins as binders, and a solvent such as ethanol, ethyl acetate or higher-boiling alcohols, esters and glycol ethers.

The colorant composition is modified with the phosphoric ester, for example, by intimately mixing these components. Alternatively, all individual components of the colorant composition may be mixed together with the phosphoric ester to give the inventive printing ink composition. However, it is also possible to initially mix individual components of the colorant composition with the phosphoric ester and subsequently combine this mixture with the remaining components.

The phosphoric esters according to the invention have outstanding long-term storage stabilities and effectiveness in surface modification, for example for hydrophobicizing organic materials such as textiles, or inorganic materials such as gypsum, cement or metals, as corrosion inhibitors, friction modifiers, emulsifiers or dispersants, adhesion promoters or printing ink additives.

The invention is illustrated by the nonlimiting examples which follow.

### EXAMPLES

### 1. Preparation of phosphoric mono(4-polyisobutylphenyl)ester dichlorides

1.1 A 1 l four-neck flask equipped with a dropping funnel, reflux condenser, bubble counter and scrubbing vessel was initially charged with 42 g of phosphorus oxide chloride and 0.25 g of aluminum chloride at room temperature, heated to 90° C. and a solution of 220 g of a 4-polyisobutylphenol (Mₙ of the polyisobutyl radical=1100, PDI=1.75) in 100 ml of heptane was added dropwise at this temperature. After an induction phase, rapid gas evolution set in which could be attributed to the formation of hydrogen chloride which was absorbed with dilute sodium hydroxide solution in a scrubbing vessel. After stirring at 100° C. for 30 minutes, excess phosphorus oxide chloride and heptane were removed distillatively at 100° C. and 100 mbar. 242.4 g of the corresponding phosphoric mono(4-polyisobutylphenyl)ester dichloride were obtained as a light oil.

¹H NMR (CD₂Cl₂, 500 MHz): 7.44 (d, J=8 Hz, 2H), 7.2 (dd,J=8 Hz (ortho-coupling) and J=2.2 Hz (P-coupling), 2H), 1.85 (s, 1H), 1.43 (s, 37H), 1.11 (s, 115H), 0.99 (s, 9H), 0.82 (s, 6H).

1.2 In a similar manner, the reactants listed in Table 1 were reacted to give the corresponding phosphoric mono(4-polyisobutylphenyl)ester dichlorides. The aromatic hydroxyl compounds used were 4-polyisobutylphenols (4-PIB-phenol). The molecular weight Mₙ of the particular polyisobutyl radicals is expressed as the Mₙ of PIB.

TABLE 1

| | | Amount | Amount | Amount | Volume | |
|---|---|---|---|---|---|---|
| Experi- | | of | of | of | of | |
| ment | Mₙ of | 4-PIB- | POCl₃ | AlCl₃ | heptane | Yield |
| No. | PIB | phenol [g] | [g] | [g] | [ml] | [g] |
| 1 | 200 | 590 | 460 | 2 | 500 | 835 |
| 2 | 550 | 650 | 234 | 1 | 250 | 775 |
| 3 | 2300 | 670 | 77 | 0.6 | 300 | 706 |
| 4 | 14000 | 100 | 1.6 | 0.05 | 100** | 92 |
| 5 | 2200* | 230 | 156 | 0.3 | 100 | 239 |

*polyisobutyl-α,ω-bisphenol; prepared according to Kennedy, Polymer Bulletin 8, 563-570 (1982)
**instead of heptane, toluene was used as the solvent.

### 2. Preparation of phosphoric mono(4-polyisobutylphenyl)esters

2.1 100 g of the product from Example 1.1, 100 ml of heptane and 10 ml of water were stirred at 50° C. for two hours. Subsequently, excess water and hydrogen chloride formed were removed on a rotary evaporator at 50° C. and a final pressure of 5 mbar. 95 g of the corresponding phosphoric mono(4-polyisobutylphenyl)ester were obtained as a light, viscous oil.

¹H NMR (CD₂Cl₂, 500 MHz): 7.34 (d, J=7.7 Hz, 2H), 7.08 (d, J=7.7 Hz (ortho-coupling), 2H), 1.83 (s, 1H), 1.43 (s, 36H), 1.11 (s, 113H), 0.99 (s, 9H), 0.82 (s, 6H).

2.2 413 g of the product from Example 1.2, Table 1, experiment No. 1 (Mₙ of PIB 200) were initially charged in heptane at room temperature in a four-neck flask and admixed dropwise with a mixture of 36 g of water and 150 ml of THF at from 20 to 30° C. within 30 minutes. The temperature increased gradually. Subsequently, the reaction mixture was heated to 60° C. and left at this temperature for a further 30 minutes, in which time gas formation was observed which could be attributed to the formation of hydrogen chloride. The batch became clear again. Finally, solvent and volatile constituents were removed on a rotary evaporator, initially at 50° C. and 4 mbar and subsequently at 100° C. and 5 mbar for 30 minutes. 400 g of the corresponding phosphoric mono(4-polyisobutylphenyl)ester were obtained as a light oil.

2.3 In a similar manner, 1026 g of the phosphoric mono(4-polyisobutylphenyl)ester dichloride from Example 1.2, Table 1, experiment No. 2 (Mₙ of PIB 550) were initially charged in 750 ml of heptane and reacted with a mixture of 48 g of water and 200 ml of THF to give the corresponding phosphoric monoester in a yield of 570 g.

### 3. Reaction of the product from Example 1.1 with triethylene glycol monomethyl ether

100 g of the product from Example 1.1 were initially charged in 100 ml of dichloromethane at room temperature and admixed dropwise at from 20 to 30° C. with a solution of 16.4 g of triethylene glycol monomethyl ether in 50 ml of dichloromethane. The reaction mixture was left at 30° C. for 16 hours while passing a gentle nitrogen stream through the solution. The initially cloudy solution became clear. Subsequently, the solvent was distilled off at 50° C. and 5 mbar on a rotary evaporator. 131.1 g of the phosphoric diester chloride of 4-polyisobutylphenol and triethylene glycol monomethyl ether were obtained as a light viscous oil. A by-product obtained was the phosphoric triester of 4-polyisobutylphenol and triethylene glycol monomethyl ether.

¹H NMR (diester; CD₂Cl₂, 500 MHz): 7.39 (d, J=8.8 Hz, 2H), 7.16 (d, J=8.8 Hz (ortho-coupling) and J=1.8 Hz (P-coupling), 2H), 4.4 (m, 2H), 3.6 (m, 6H), 3.5 (m, 2H), 3.3 (s, 3H).

s=singlet

d=doublet

dd=doublet of doublets

### 4. Use examples

A) Hydrophobization of a Metal Surface:

A 0.2% solution of a mono(4-polyisobutylphenyl) phosphate was prepared by mixing 898 parts by weight of distilled water, 100 parts of Emulan® HE 50 (nonionic emulsifier from BASF AG, Ludwigshafen) and 2 parts of polyisobutylphenoxyphosphoric acid from example 2.3.

An aluminum sheet was immersed in this solution for 17 h and rinsed with a lot of water. For comparison, an aluminum sheet was immersed in a solution of 100 parts of Emulan® HE 50 in 900 parts by weight of distilled water for 17 h.

Water drops on the sheet surface exhibited the following contact angle:

| | |
|---|---|
| inventive: | 102° |
| comparative: | 65° |

B) Corrosion Protection:

For the sheets obtained in example A), the electrochemical key parameters determined were the breakdown potential (in 0.6 mol/l NaCl and sat. Ca(OH)₂), the corrosion current and the polarization resistance.

| | |
|---|---|
| Comparative | Inventive |

| | | | | |
|---|---|---|---|---|
| Breakdown potential | −550 | mV | −400 | mV |
| Corrosion current | 2700 | μA/cm² | 1100 | μA/cm² |
| Polarization resistance | 50 | kΩ | 140 | kΩ |

The values demonstrate a significant reduction in the corrosion in the case of the sheet treated in accordance with the invention.

C) Emulsifying Action

A 10% solution of a mono(4-polyisobutylphenyl) phosphate was prepared by mixing 90 parts by weight of kerosene and 10 parts of polyisobutylphenoxyphosphoric acid from example 2.3. Aliquots of this solution and a solution of NaHCO₃ in water (2 parts by weight in 98 parts of water) was stirred with ice cooling at 24 000 rpm using a rapid stirrer for 10 minutes. For comparison, the experiment was carried out without the polyisobutylphenoxyphosphoric acid; the stability of the emulsions was assessed.

Inventive: after 14 days still complete emulsification

Comparative: after 1 day complete demixing

D) Adhesion Promoter in Film Printing:

The adhesion promotion of a polyisobutylphenoxyphosphoric acid-containing printing ink system on polypropylene film was determined in comparison to a standard system (without polyisopbutylphenoxyphosphoric acid) using the “Tesa strength” test method.

Preparation of the Printing Paste

The following standard formulation was used (parts by weight):

| | |
|---|---|
| 70.0 | pigment preparation (from BASF Drucksysteme) |
| 8.0 | nitrocellulose (from Wolf) |
| 1.0 | oleamide (from Croda) |
| 0.5 | polyethylene waxes (from BASF AG) |
| 2.0 | dibutyl phthalate (from Brenntag) |
| 10.5 | ethanol |
| 5.0 | polyisobutylphenoxyphosphoric acid from |
| | example 2.1 (only in inventive printing paste) |

The ink diluted to a viscosity suitable for printing was printed onto polypropylene film (MB400).

Procedure of the “Tesa Strength” Test

A Tesa tape strip (adhesive tape of width 19 mm (article BDF 4104, Beiersdorf AG)) was stuck onto the printing ink film, pressed on uniformly and torn off again after 10 seconds. This operation was repeated 4 times at the same point on the specimen in each case using a new Tesa tape strip. Each Tesa strip was stuck successively onto white paper; to black paper in the case of white inks. The testing was effected immediately after application of the ink.

The surface of the specimen was tested visually for damage. The marks were on a scale from 1 (very poor) to 5 (very good).

| | |
|---|---|
| Inventive: | 4 |
| Comparative: | 1 |

1. A phosphoric ester of the formula I 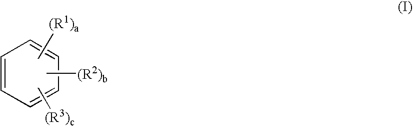
where
each R¹ is independently a group 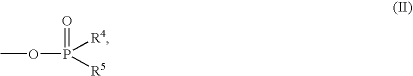
R⁴ and R⁵ are each independently halogen, OR⁶, SR⁶, NR⁶R⁷ or a 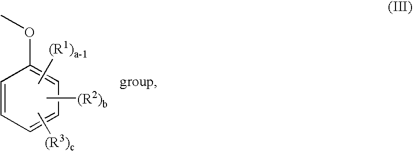
R⁶ and R⁷ are each independently H, C₁-C₂₀-alkyl or C₂-C₄₀₀₀-alkyl which is interrupted by at least one moiety which is selected from O, S and NR⁸, and R⁶ and R⁷ together with the nitrogen atom to which they are bonded may also form a ring, and R⁶ and R⁷ are also aryl, aralkyl or cycloalkyl; and
R⁸ is as defined for R⁶ and R⁷;
R² is a polyisobutene radical;
each R³ is independently OH, C₁-C₂₄-alkyl, C₁-C₂₄-alkoxy or halogen;
a and b are each a number from 1 to 3 and
c is a number from 0 to 4,
where the sum of a, b and c is from 2 to 6,
and salts thereof.

2. The phosphoric ester as claimed in claim 1, wherein a is 1.

3. The phosphoric ester as claimed in claim 1, wherein b is 1 or 2.

4. The phosphoric ester as claimed in claim 1, wherein c is 0 or 1.

5. The phosphoric ester as claimed in claim 1, wherein R² is a radical derived from a reactive polyisobutene.

6. A process for preparing the phosphoric ester as defined in claim 1, comprising
a) reacting an aromatic hydroxyl compound of the formula V 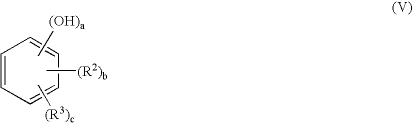
where R² and R³ and also a, b and c are each as defined above with a phosphorus oxide halide and
b) subsequently reacting the reaction product from step a) optionally with water, at least one alcohol, at least one thiol and/or at least one amine.

7. A phosphoric ester-containing composition obtained by
a) reacting an aromatic hydroxyl compound of the formula V a with a phosphorus oxide halide and
b) subsequently reacting the reaction product from step a) optionally with water, at least one alcohol, at least one thiol and/or at least one amine.

8. A composition comprising the phosphoric ester as claimed in claim 1 wherein the composition is utilized for the surface modification of an organic or an inorganic material, as a corrosion inhibitor, as a friction modifier, as an emulsifier, as a dispersant, as an adhesion promoter, as a wetting agent, as a wetting inhibitor, as a volatilizing agent or as a printing ink additive.

9. The composition as claimed in claim 8, wherein R⁴ and R⁵ are each independently OR⁶, SR⁶ or NR⁶R⁷.

10. A fuel and lubricant additive comprising the phosphoric ester as defined in claim 1.

11. A fuel and lubricant composition comprising a main amount of a hydrocarbon fuel or of a lubricant and the phosphoric ester as defined in claim 1 and also optionally at least one further additive.

12. An additive concentrate comprising the phosphoric ester as defined in claim 1 and at least one diluent and optionally at least one further additive.

13. A printing ink comprising the phosphoric ester as defined claim 1 and at least one colorant.

14. A composition comprising the phosphoric ester as claimed in claim 7, wherein the composition is utilized for the surface modification of an organic or an inorganic material, as a corrosion inhibitor, as a friction modifier, as an emulsifier, as a dispersant, as an adhesion promoter, as a wetting agent, as a wetting inhibitor, as a volatilizing agent or as a printing ink additive.

15. The composition as claimed in claim 14, wherein R⁴ and R⁵ are each independently OR⁶, SR⁶ or NR⁶R⁷.

16. A fuel and lubricant additive comprising the phosphoric ester as defined in claim 7.

17. A fuel and lubricant composition comprising a main amount of a hydrocarbon fuel or of the lubricant and the phosphoric ester as defined in claim 7 and also optionally at least one further additive.

18. An additive concentrate comprising the phosphoric ester as defined in claim 7 and at least one diluent and optionally at least one further additive.

19. A printing ink comprising the phosphoric ester as defined in claim 7 and at least one colorant.
